(19) United States
(12) Patent Application Publication
(10) Pub. No.: US 2011/0206526 A1
(43) Pub. Date: Aug. 25, 2011

(54) VERTICAL-AXIS WIND TURBINE HAVING LOGARITHMIC CURVED AIRFOILS

(76) Inventor: Gary D. Roberts, Montpelier, ID (US)

(21) Appl. No.: 12/710,506

(22) Filed: Feb. 23, 2010

(51) Int. Cl. F03D 3/06; F03D 3/02

(52) U.S. Cl. 416/223 R

(57) ABSTRACT

A vertical-axis, stator-less wind turbine includes a rotor rotatable about a vertical axis. The rotor has a plurality of vertically oriented rotor airfoils disposed circumferentially and with equiangular symmetry about the vertical axis. Each rotor airfoil has a substantially logarithmic curvature.

### BACKGROUND

1. Field of the Invention

The present invention relates generally to a vertical axis wind turbine.

2. Related Art

The ever increasing threat of global warming due to our increased use and dependence upon polluting fossil fuels, dictates a sense of urgency for us to escalate our current use of wind power in combating these global warming emissions. Wind energy is one of the most cost effective and environmentally friendly technologies we can deploy in combating said threat. As responsible people, we should take advantage of our inexhaustible sources of wind energy as much as possible.

Vertical-axis wind turbines have many advantages over their horizontal-axis counterpart. For example, they are easy to install and maintain, as well as being considered by most to be more aesthetically pleasing to eye as well as being more environmentally suitable than their horizontal-axis counterpart turbines. More often than not, however, the most efficient turbines of this vertical-axis group are usually very costly due to their need for a stationary stator element in addition to their rotating element in order to block or reduce back pressure on the antipodal or return side of the rotor blades. Examples of vertical-axis wind turbines with stationary stators include U.S. Pat. Nos. 5,380,149 to Valsamidis and 6,465,899 to Roberts. Also, many of the prior art turbines of said group that do not employ such a stator element are merely drag machines that use flat or cup-shaped blades to move the rotor around a vertical-axis. Examples of stator-less wind turbines include U.S. Pat. Nos. 1,766,765 to Savonius; 4,005,947 to Norton et al.; 4,359,311; 4,715,776 and 5,494,407 to Benesh. To improve turbine efficiency, modern wind turbine designs use aerodynamic lift principles to drive their airfoil blades. These airfoil blades typically have a very high lift-to-drag ratio, which in turn is an assessment used in the determination of their performance. An example of vertical-axis wind turbines with improved airfoil blades includes U.S. Pat. No. 7,329,965 to Roberts. Optimized blade profiles have also been proposed in U.S. Pat. No. 7,393,177 to Rahai et al. At best, true drag machines can only capture about 4/27ths of the power available in the wind. By comparison, properly designed lift machines have the theoretical hypothesis of capturing up to the Betz limit of 16/27ths of the available power in the wind, thereby providing nearly four times more energy output for the same windswept rotor area.

Furthermore, many present art vertical-axis wind turbine blades are shaped so as to cause the air or wind to become turbulent either upon entering or exiting the rotor, resulting in excessive noise and dampened efficiencies.

### SUMMARY OF THE INVENTION

It has been recognized that it would be advantageous to develop an improved vertical axis wind turbine.

The invention provides a wind turbine with a rotor rotatable about a vertical axis. The rotor has a plurality of vertically oriented rotor airfoils disposed circumferentially and with equiangular symmetry about the vertical axis. Each rotor airfoil has a substantially logarithmic curvature. A trailing edge can have a smaller radius of curvature than a leading edge. The leading edge can be positioned further from the vertical axis than the trailing edge.

In addition, the invention provides a wind turbine including a rotor rotatable about a vertical axis without stationary stator airfoils or stator vanes disposed outside of the rotor. The rotor has a plurality of vertically oriented rotor airfoils disposed circumferentially and with equiangular symmetry about the vertical axis. Each rotor airfoil has: a spheroidal nose at the leading edge; a tapered trailing edge; a continuously concave inner surface with a logarithmic curvature; and a continuously convex outer surface with a different logarithmic curvature than the concave inner surface. A generator is coupled to the rotor.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a perspective view of a three-stage vertical-axis wind turbine of the present invention, so oriented as to be efficiently operable in the northern hemisphere according to the present invention;

FIG. 2 is a cross-sectional view of the central rotor stage or tier of the turbine of FIG. 1, taken along line 2-2, showing the involute layout or arrangement of its high-lift airfoils blades, said airfoil blades being disposed or offset from one another with equiangular symmetry;

FIG. 3 is a sectional view of a prior art turbine rotor showing two hemicyclic blades being offset substantially by the length of the radius of the blades and angularly disposed said rotor by 180 degrees;

FIG. 4a is a top view of the turbine shown in FIG. 1 showing the involute arrangement, and the angular transition of its various airfoil blades and respective tiered rotor stages;

FIG. 4b is a mirror image of the top view of the turbine shown in FIG. 1, said turbine having its vertical-axis swapped or transposed so as to be efficiently operable in the southern hemisphere;

FIG. 5 is a perspective view of the center rotor stage or tier 30, as employed in FIG. 1, showing its spiral chambered construction;

FIG. 6 is a top view of the involute airfoil attachment plates 33 and 37 of FIG. 5, said attachment plates providing strength and mechanical reinforcement between the rotor airfoils as well as providing a means of transferring torque from the rotor airfoils blades to the rotating axial shaft 10, via torque transfer plate and tapered expansion hub 21 of the present invention;

FIG. 7a is an exploded perspective view of the rotor shown in FIG. 6 showing lower involute airfoil attachment plate 33, torque transfer plate and tapered expansion hub assembly 21, high-lift airfoils blades 35a, 35b, and 35c, and upper involute airfoil attachment plate 37;

FIG. 7b is a perspective view of a high-lift airfoil blade 35a of FIG. 7a being designed with the discretionary variform aerodynamic slots 70 engineered into its concave suction surface to enhance the aerodynamic lift properties of the airfoil blades of the present invention;

FIG. 8a is a cross-sectional view of the three-stage vertical-axis wind turbine of FIG. 1 taken along line 1-1, showing the layout and arrangement of the lower rotor terminus, its reinforcement annulus 15b, its involute airfoil attachment plate 23, its torque transfer plate and tapered expansion hub 11, its axial shaft 10, and its high-lift airfoils blades 25a, 25b, and 25c, showing their helical construction;

FIG. 8b is a cross-sectional view of the three-stage vertical-axis wind turbine of FIG. 1 taken along line 3-3, showing the layout and arrangement of the upper rotor terminus, its reinforcement annulus 15a, its involute airfoil attachment plate 47, its torque transfer plate and tapered expansion hub 41, its axial shaft 10, and its high-lift airfoils blades 45a, 45b, and 45c, showing their helical construction;

FIG. 9 is a schematic view of the physical parameters of an ellipse used in the design and construction of the logarithmically curved high-lift airfoils blades for the several rotor stages of FIG. 1;

FIG. 10a is a schematic view of an arc segment of the ellipse of FIG. 9, wherein said arc segment represents the logarithmic curve used to construct the outer airfoil suction surface of the logarithmically curved high-lift airfoils blades utilized in the several rotor stages of FIG. 1;

FIG. 10b is a schematic view of the arc segment generated in FIG. 10a, wherein said arc segment represents the logarithmic curve used to construct the outer airfoil suction surface of the logarithmically curved high-lift airfoils blades utilized in the several rotor stages of FIG. 1;

FIG. 11a is a schematic view of an arc segment of the ellipse of FIG. 9, wherein said arc segment represents the logarithmic curve used to construct the inner airfoil pressure surface of the logarithmically curved high-lift airfoils blades utilized in the several rotor stages of FIG. 1;

FIG. 11b is a schematic view of the arc segment generated in FIG. 11a, wherein said arc segment represents the logarithmic curve used to construct the inner airfoil pressure surface of the logarithmically curved high-lift airfoils blades utilized in the several rotor stages of FIG. 1;

FIG. 12 is a schematic view of how the outer airfoil suction surface arc of FIG. 10b, the inner airfoil pressure surface arc of Fig. of FIG. 11b are aligned and arranged so as to accommodate or accept the semicircle spheroidal nose or leading edge construct so as to fashion one of the high-lift airfoils blades of the present invention utilized in the several rotor stages of FIG. 1;

FIG. 13 is a schematic view of the appreciable camber utilized in the design of the logarithmically curved high-lift airfoils blades utilized in the several rotor stages of FIG. 1;

FIG. 14a is a schematic view of the chord line of high-lift airfoil blades of the present invention being angularly skewed 10.51 degrees from the rotor radius, thus creating an open center construct 54 equal to 23.84% the diameter of the rotor;

FIG. 14b is a schematic view of the chord line of high-lift airfoil blades of the present invention being angularly skewed 15.51 degrees from the rotor radius, thereby creating an open center construct 54 equal to 31.00% the diameter of the rotor;

FIG. 15 is a schematic view of how lift is generated via the curved airfoils blades utilized in the several tiered rotor stages of FIG. 1;

FIG. 16 is a schematic view of how the wind or air flowing around each rotor airfoil blades of the turbine in FIG. 1 forms areas of high and low pressure which results in substantial lift and appreciable rotating torque;

FIG. 17a is a perspective view of a latticework tower arrangement 60 that could be utilized as a supporting means for the operation of turbine 5 of FIG. 1;

FIG. 17b is embodiment perspective view of the turbine of FIG. 1, shown again here for illustrative convenience, said turbine having an elongated lower shaft so as to be adaptable to be mounted on the latticework tower arrangement shown in FIG. 16a;

FIG. 18 is a perspective view of the latticework tower of FIG. 16a combined with the turbine of FIG. 16b to provide an operable mounting strategy for present invention; and

FIG. 19 is a perspective view of several turbines of the present invention operable within a small footprint.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

It is an object of the present invention to eliminate the need for a stator/rotor combination design by employing a more aerodynamic design to the rotor airfoil blades of a new vertical-axis wind turbine wherein these enhanced aerodynamic lift principles in its design can provide both a cost effective as well as cost competitive, pollution free alternative to new coal or gas fired power plants and in turn provide a large, rapid, and more responsible part in the solution to our global warming menace.

With the foregoing background of the present invention in mind, and as descriptions of the various embodiments and distinguishing characteristics proceed, it will be appreciated that it is desirable to provide a dynamic vertical axis wind turbine, wherein the rotor of said turbine has been optimized omni directionally to provide wind energy extraction capabilities that border the currently understood theoretical limits, over an extended range of wind velocities and/or altitudes.

It is further desirable to provide an efficient and effective rotor design, wherein its dynamic rotor blade structure will produce a protective bow shock wave on its upstream side to self-limit energy production when wind pressure levels approach destructive levels, thus constraining excess wind to flow more easily around the turbine rather than through it.

It is further desirable to provide an efficient and effective means to adjust the wind energy harvesting potential, of the present invention, by accommodating appropriately engineered discretionary laminar flow control mechanisms, such as aerodynamic variform slots and/or suction grooves, especially in very large turbine elements, thereby, augmenting the aerodynamic lift potential of the apparatus, while concurrently minimizing any ensuing turbulence.

It is further desirable to provide an efficient and effective means to enhance overall structural integrity, by means of an appropriately sized central shaft or spindle, based primarily, but not exclusively, on installation site and/or implementation parameters.

It is further desirable to yield a variety of embodiments of the present invention, adaptable and suited to implementation and/or installation site requirements, in order to maximize the wind energy harvesting potential of the present invention, for any given wind regime, by means of an appropriately engineered adjustment to the total number of rotor stages or tiers.

It is further desirable to yield a variety of embodiments, of the present invention, adaptable and suited to implementation and/or installation site requirements, in order to facilitate the stabilization of any implementation, by means of guy cables, or other such systems and technologies, as may be deemed appropriate by those skilled in the art.

It is further desirable to yield a variety of embodiments of the present invention, adaptable and suited to implementation and/or installation site requirements, so as to accommodate an open ended mounting paradigm. Moreover, the present invention can accommodate virtually any viable mounting scheme. Moreover, base or mounting structures can have any particularized shape or proportion requirements and any constituent coupling provisions, which may appropriately vary for each implementation of the present invention.

It is further desirable to yield a variety of embodiments of the present invention, adaptable and suited to implementation and/or installation site requirements, so as to accommodate the utilization of any viable type or combination of fabrication materials and/or construction methodologies, based primarily, but not exclusively, on installation site and/or implementation parameters.

It is further desirable to yield a variety of embodiments that may correct for the antipodal Coriolis forces, known to exist between the northern and southern hemispheres, by providing a means for the elective reversal of the vertical mounting orientation of the rotor element of the present invention, so as to create an optimized design implementation that will have a counter-clockwise spiral of the rotors airfoil blades for installations in the northern hemisphere, and a clockwise spiral of the rotors airfoil blades for installations in the southern hemisphere.

It is further desirable to yield a variety of embodiments of the present invention, adaptable and suited to implementation and/or installation site requirements, so as to provide ameliorated domain insensitivity. Thereby, facilitating installations of the present invention in areas where prior art turbines either cannot operate, or cannot be installed, due to inherent structural design limitations or safety concerns, such as within or atop tall building structures.

It is further desirable to yield a variety of embodiments that may achieve the aforementioned objectives with a minimal compliment of moving parts, environmental concerns, maintenance requirements and/or impediments, as well as reduced manufacturing, operational, and installation expenses.

The present invention relates to an omni-directional wind turbine and more particularly to a vertical-axis turbine with an improved capability of converting wind power to mechanical or electrical power. The present invention provides a new and improved, wind turbine apparatus substantially exhibiting the following characteristics: (1) Resolves many of the disadvantages of prior art; (2) Provides optimal energy transference from wind power to rotational torque by omni directionally channelizing wind through various rotor stages via logarithmically curved airfoils; said airfoils having a spheroidal leading edge; a tapered trailing edge; a continuously concave curved inner pressure surface extending smoothly and logarithmically without discontinuity from the spheroidal nose section to the tapered trailing edge; a continuously convex curved outer suction surface extending smoothly and logarithmically without discontinuity from the spheroidal nose section to the trailing edge; and a thin or tapered aft section formed contiguous the trailing edge and between the pressure surface and the suction surface; said airfoil blades being disposed or offset with respect to said rotor stage with equiangular symmetry so as to reduce back pressure, decrease turbulence, improve laminar streamlined airflow, reduce drag, and substantially intensify overall torque; (3) Smooths out and reduces torque pulsations by transitionally optimizing the number of rotor airfoil blades in regard to their various alignments with respect to the wind channeled through the various multi-tiered rotor stages, as well as providing mechanical balance, strength, and stabilization to the turbine's rotational components; and (4) Provides a constricted vertical flow thereby increasing the air velocity through the central portion of the rotor.

The above objectives are realized in the present invention by providing a vertical-axis wind turbine, said turbine having a plurality of rotor stages or tiers, each stage or tier having a plurality of logarithmically curved, high-lift airfoils, said airfoils having a spheroidal leading edge; a tapered trailing edge; a continuously concave curved inner pressure surface extending smoothly and logarithmically without discontinuity from the spheroidal nose section to the tapered trailing edge; a continuously convex curved outer suction surface extending smoothly and logarithmically without discontinuity from the spheroidal nose section to the trailing edge; and a thin or tapered aft section formed contiguous the trailing edge and between the pressure surface and the suction surface; said airfoil blades being disposed or offset said rotor stage with equiangular symmetry so as to form a central vortex, reduce back pressure, decrease turbulence, reduce drag and uninterrupted flow of the air boundary layer thereby producing streamlined laminar flow both through and around the rotor structure. Fluid air pressure in said vortices is lowest in the central portion of the rotor, where the speed is greatest, and rises progressively with distance from the center. This is in accordance with Bernoulli's Principle. In other words, the speed and flow rate of the incoming, as well as the exhausting air is greatest at the central vortex of said rotor stages and decreases progressively with distance from the center. At the rotor's central axis, the vorticity or rotary flow of the incoming air flow flip-flops or changes direction as it exits through the antipodal airfoils, producing positive lift and effective torque for a full 360 degrees of rotation, virtually eliminating static back pressure. This flip-flop action of the rotor airflow eventuates three times per revolution or for every 120 degrees of rotation throughout each of the rotor stages. Total torque and resulting output power of the turbine is based upon Bernoulli's Principle of lift and Newton's second law of motion as it relates to the net forces of the wind stream velocity in contact with the rotor's area, and the mass density of the airflow.

Having separate stages or tiers within the rotor smooths out and eliminates output torque pulsations by transitionally optimizing the number of rotor blades in direct alignment or at their maximum angles of attack with respect to relative wind flow throughout the rotor, as well as providing balance, strength, and stabilization to the entire rotor element while at the same time increasing the operational aspect ratio of the combined airfoil blades.

Unlike the typical standard art vertical turbines, which produce torque at the expense of salient back pressure, this topological configuration, enhances or maximizes the induced torque on the rotor element at all angles of attack and is proven by applying Bernoulli's equation to the air stream flowing through the rotor and around each of its high-lift airfoil blades. Those skilled in the art will understand and appreciate that maximum static atmospheric pressure occurs within the concaved or stagnation area of the airfoil blade at which the air stream velocity equals zero. This takes place in the present invention near the spheroidal leading edges on the inner concaved pressure surface of the airfoils, placing the maximum lift and resultant torque in the most advantageous and effective area to maximize rotor efficiency.

Hence, the present invention provides the following: (1) A substantial increase in atmospheric pressure on the concaved side of the rotor high-lift vortical airfoils, a substantial decrease in atmospheric pressure on the convex side of said airfoils along with a unique angle of attack provided by the logarithmic spiraled curvature of airfoils; (2) A unique rotor structure which allows rapid vortical air flow through each of its skewed stages, providing a smooth combined output torque from each of the rotor's logarithmically curved airfoil blades at all angles of attack for a full 360 degrees of rotation; (3) A further increase in the total torque applied to the rotor resulting from the venturi effect or negative pressure created as circumferential air flows around the rotor's unique airfoil blades, netting an unsurpassed output torque per windswept area for a full 360 degrees of rotation of the rotor; (4) The ability to change vertical orientation of the rotor element so as to provide a turbine having a counter-clockwise spiral of the rotors airfoil blades for locations in the northern hemisphere and a clockwise spiral of the rotors airfoil blades for the southern hemisphere, allowing the present invention to further take advantage of the earth's Coriolis effect or force; (5) The unique profile of the present invention permits installation in areas where present art turbines either cannot operate or cannot be installed, such as atop tall building, due to structural design or safety concerns; and (6) The vertical-axis wind turbine can be safely and efficiently operated over an expanded range of wind velocities due to its efficient and effective rotor design, wherein the dynamic rotor airfoil structures produce a protective bow shock wave on its upstream side to self-limit energy production when wind pressure levels approach destructive levels, thus constraining excess wind to flow more easily around the turbine rather than through it.

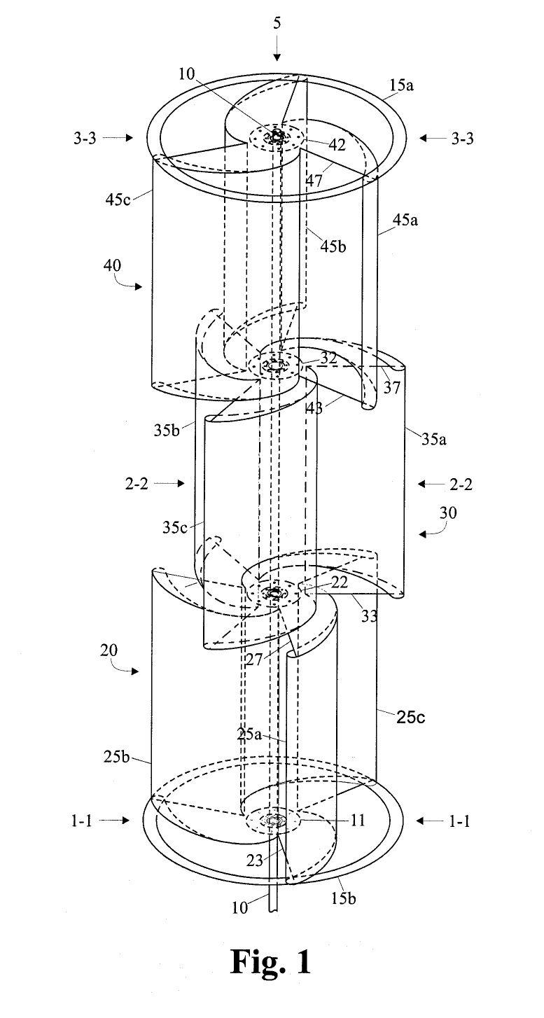

Referring more particularly now to the drawings of the present invention, FIG. 1 exemplifies a vertical axis wind turbine or rotor 5, having an intentionally open-ended mounting strategy for rotation and operation in the northern hemisphere. The rotor is rotatable on a shaft or about a vertical axis 10. The rotor can be stator-less, or without stationary airfoils or stator vanes disposed outside the rotor.

Examining more fully, the details of present invention, FIG. 1, shows said turbine as having upper and lower reinforcement annuluses 15a & 15b, respectively. These reinforcement annuluses are attached to involute airfoil attachment plates 23 & 47 providing strength thereto by forming a gusset between the tips of said airfoil plates 23 & 47, and they provide a rolling and supporting surface or means when the turbine is laying horizontally on the ground or other surface, thereby preventing or eliminating damage from occurring to the turbine airfoil blades.

Again referring to FIG. 1, turbine or rotor 5 is shown having three sections 20, 30 and 40, or tiers, or modules, separated by involute airfoil attachment plates 27, 33, 37 and 43. The sections, tiers or modules can be stacked together in a vertical series with collinear vertical axes, such as a common shaft 10. Each tier employs a plurality of high-lift rotor airfoils or airfoils blades, such as three. The rotor airfoils of each section or tier can be bound by a pair of attachment plates. For example, the first or lowest tier 20 has three rotor airfoils 25a, 25b and 25c bound between a pair of attachment plates 23 and 27. Similarly, the middle tier 30 has three rotor airfoils 35a, 35b and 35c bound between a pair of attachment plates 33 and 37. Similarly, an upper tier 30 has three rotor airfoils 45a, 45b and 45c bound between a pair of attachment plates 43 and 47. Therefore, each section or tier can be a structurally independent module. Adjacent attachment plates 27 and 33, or 37 and 43, between adjacent tiers can be attached to one another to form the stacked turbine or rotor.

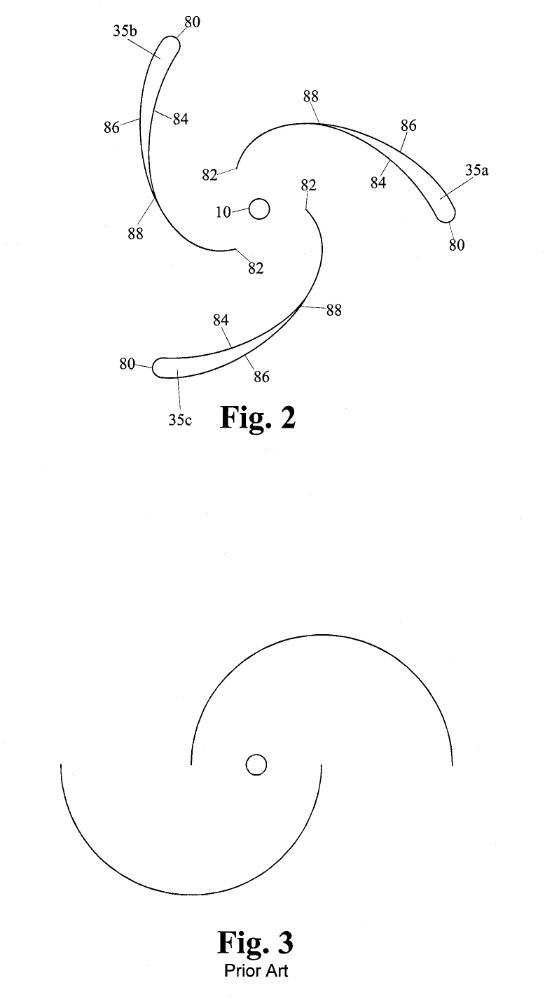

The airfoils or blades (represented by 35a, 35b and 35c in FIG. 2) can generally or substantially have a logarithmic curvature or logarithmically shaped curvature. Each airfoil or blade has a spheroidal (or partial spheroidal or curved) leading edge 80; a tapered trailing edge 82; a continuously concave curved inner pressure surface 84 extending smoothly and logarithmically without discontinuity from the spheroidal nose section to the tapered trailing edge; a continuously convex curved outer suction surface 86 extending smoothly and logarithmically without discontinuity from the spheroidal nose section to the trailing edge; and a thin or tapered aft section 88 formed contiguous the trailing edge and between the pressure surface and the suction surface; said airfoil blades being disposed or offset from one another with equiangular symmetry of 120 degree increments, and each tier being offset sequentially from one another by substantially 40 degrees. The inner and outer surfaces 84 and 86 have a smooth curve that is continuously concave and convex, respectively, without alternating between convex and concave. The logarithmic curvature of the inner and outer surfaces 84 and 86 can vary the radius of curvature between the leading and trailing edges, with the trailing edge 82 can have a smaller radius of curvature than the leading edge 80. The airfoils can be oriented with the leading edge 80 positioned further from the vertical axis than the trailing edge 82.

Lower rotor tier 20 of FIG. 1 is shown having three high-lift airfoil blades 25a, 25b, and 25c, said blades being attached to lower and upper involute airfoil attachment plates 23 & 27 respectively; the lower involute airfoil attachment plate 23 is bolted or secured to torque transfer plate and tapered expansion hub assembly 11 connecting said attachment plate to shaft or axis 10.

Central rotor tier 30 of FIG. 1 is shown having three high-lift airfoil blades 35a, 35b, and 35c, said blades being attached to lower and upper involute airfoil attachment plates 33 & 37 respectively; the lower involute airfoil attachment plate 33 and upper involute airfoil attachment plate 27 of lower tier 20, are bolted or secured to torque transfer plate and tapered expansion hub assembly 22, connecting said attachment plates 27 & 33 to shaft or axis 10.

Upper rotor tier 40 of FIG. 1 is shown having three high-lift airfoil blades 45a, 45b, and 45c, said blades being attached to lower and upper involute airfoil attachment plates 43 & 47 respectively; the lower involute airfoil attachment plate 43 and upper involute airfoil attachment plate 37 of central tier 30, are bolted or secured to torque transfer plate and tapered expansion hub assembly 32, conjoining said attachment plates 37 & 43 to shaft or axis 10; upper involute airfoil attachment plate 47 of upper tier 40, is bolted or secured to torque transfer plate and tapered expansion hub assembly 42, connecting said attachment plate 47 to shaft or axis 10.

Referring more particularly now to FIG. 2, which is a sectional view of the central rotor stage or tier of the turbine of FIG. 1 taken along line 2-2, one can see more clearly the involute or spiraled layout or arrangement of the high-lift airfoils blades utilized in the present invention. As mentioned earlier, said blades are formed so as to have a spheroidal leading edge 80; a tapered trailing edge 82; a continuously concave curved inner pressure surface 84 extending smoothly and logarithmically without discontinuity from the spheroidal nose section to the tapered trailing edge; a continuously convex curved outer suction surface 86 extending smoothly and logarithmically without discontinuity from the spheroidal nose section to the trailing edge; and a thin or tapered aft section 88 formed contiguous the trailing edge and between the pressure surface and the suction surface; said airfoil blades being disposed or offset from one another with equiangular symmetry or at 120 degree increments.

By comparison, FIG. 3 visually demonstrates the dramatic difference between the blades of the present shown in FIG. 2 as compared to a similar prior art vertical turbine construct. As one skilled in the art can clearly see, the prior art rotor construct does not provide an increase in the air velocity as it flows through the central portion of the rotor, thus providing very little lift potential, thereby resulting in a very high drag to lift ratio. As such, it operates in the efficiency range more closely associated with that of a true drag machine, harvesting only about 4/27ths of the power available in the wind. By comparison, those skilled in the art will readily appreciate how the construct of the present art high-lift airfoil blades as utilized in the present invention, will clearly provide a substantial increase in the air velocity through the involute central portion of the rotor construct, thereby providing substantial lift and rotational torque according to the Bernoulli principle. Thus, as mentioned earlier, the construct of the present invention will have the theoretical potential or hypothesis of capturing up to the Betz limit of 16/27ths of the available power in the wind, providing nearly four times more energy output for the same windswept rotor area.

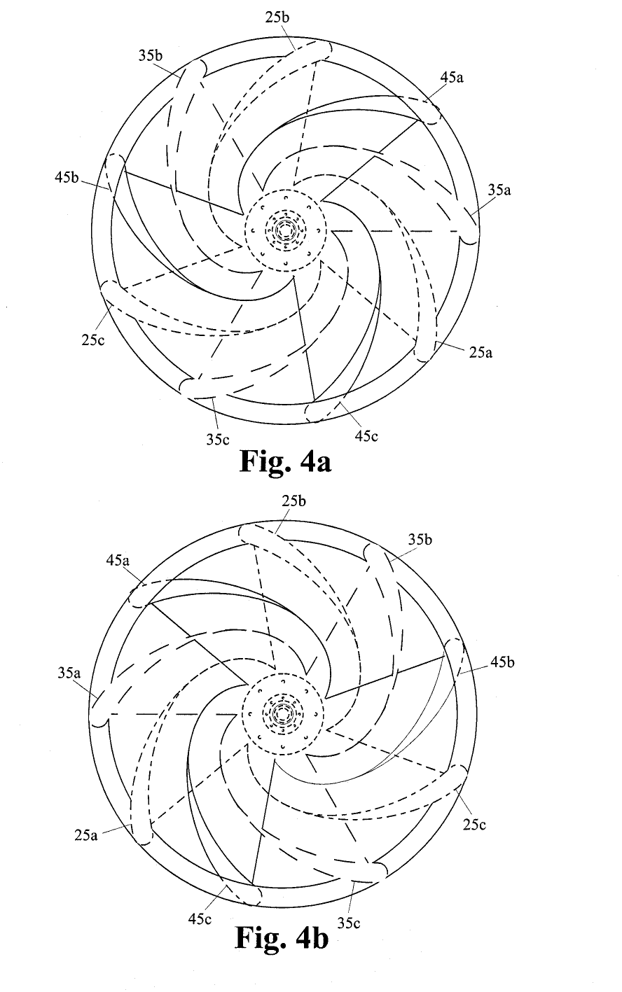

Those skilled in the art will quickly recognize and appreciate yet another construct feature of the present art vertical wind turbine by referring more particularly to FIG. 4a and FIG. 4b. As can be seen, from these top view illustrative drawings, the tiered arrangement of the present art turbine, provides a more steady-state rotational torque component by providing the angular transition of its various airfoil blades 22a, 22b, 22c 35a, 35b, 35c, 45a, 45b, and 45c of the respective tiered rotor stages 20, 30, and 40, that the angular displacement said airfoil blades has an average angular blade displacement of 40 degrees rather than the 120 degree displacement for any single stage rotor construct of the present invention. Thus, those skilled in the art will recognize how by adding additional tiered sections to the present art rotor construct would even further enhance and smooth out the total rotational torque component of the present disclosed invention.

Also, as mentioned earlier, it is a desirable object of the present invention to provide embodiments that may correct for the antipodal Coriolis forces, known to exist between the northern and southern hemispheres, by providing a means for the elective reversal of the vertical mounting orientation of the rotor element of the present invention, so as to create an optimized design implementation that will have a counter-clockwise spiral of the rotors airfoil blades for installations in the northern hemisphere, and a clockwise spiral of the rotors airfoil blades for installations in the southern hemisphere. Therefore, FIG. 4a shows an embodiment of the present invention that would be used for efficacious operation in the northern hemisphere, and FIG. 4b is a mirror image of the top view of the turbine shown in FIG. 4a, said turbine having its vertical-axis swapped or transposed so as to be efficaciously operable in the southern hemisphere.

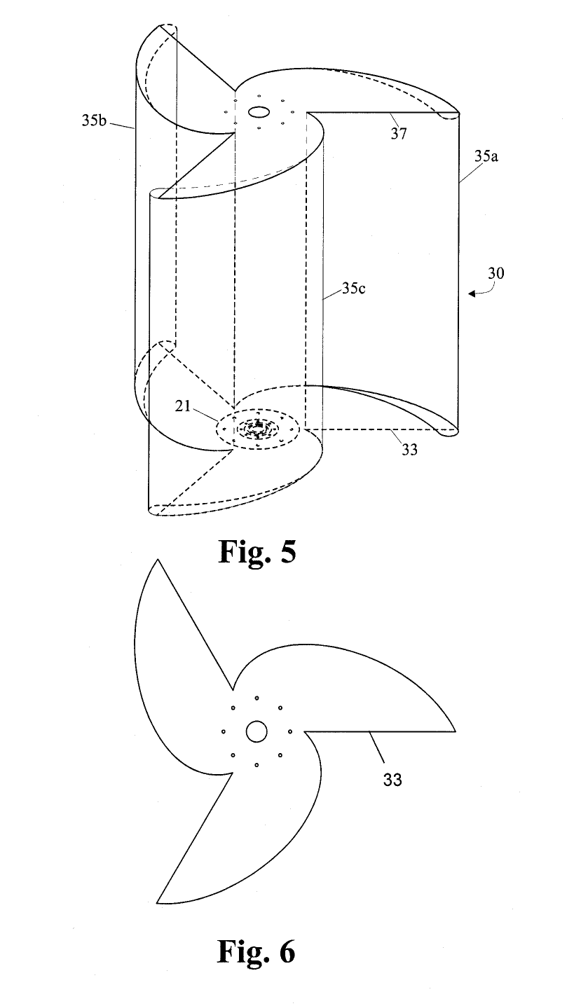

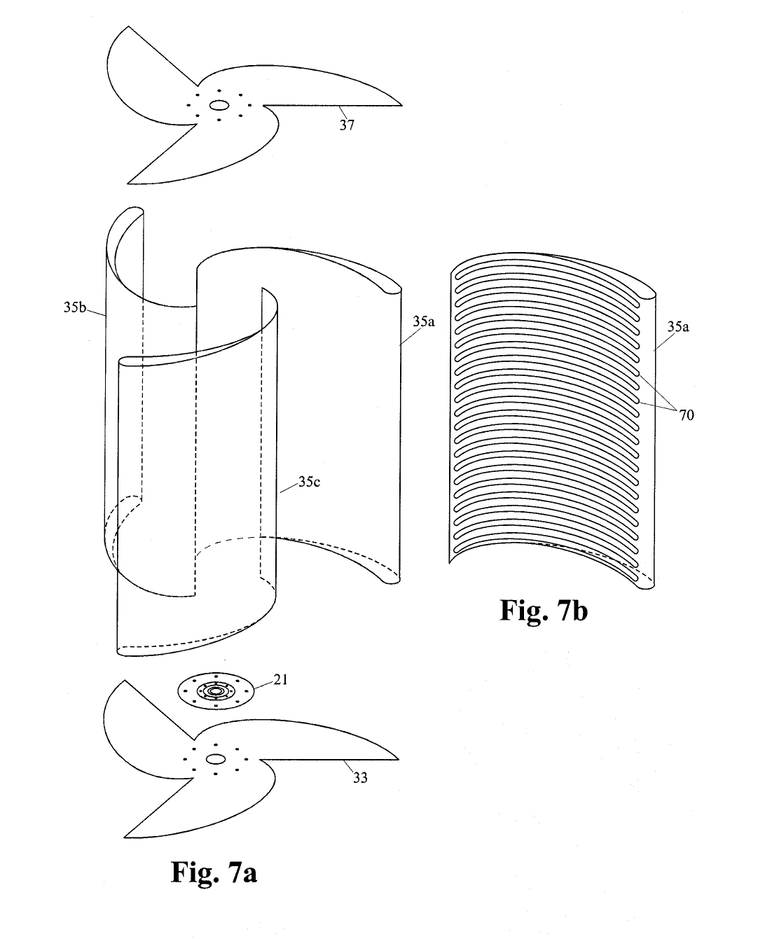

For intercalary illustrative purpose FIG. 5 shows the spiral chambered construction of central rotor stage or tier 30 of FIG. 1 as employed in the present invention, depicting its three high-lift airfoil blades 35a, 35b, and 35c attached to both lower and upper involute airfoil attachment plates 33 & 37 respectively; wherein the lower involute airfoil attachment plate 33 is bolted or secured to torque transfer plate and tapered expansion hub assembly 21, said expansion hub assembly being the connective compression means of connecting and transferring torque applied to the reinforcements plates 33 & 37 to the rotor axel or shaft. FIG. 6 further illustrates the involute airfoil attachment plate 33 used to support the rotor turbine airfoil blades of the present invention. The attachment plates (represented by 33 in FIG. 6) can include a plurality of radiating petals shaped as the outer concave surface of the rotor airfoil and its associated chord, with the inner portion of the plates attached to the hub assembly and the distal tips of the petals attached to the leading edges of the airfoils. Alternatively, the attachment plates can be a circular plate. Furthermore, FIG. 7a illustrates with enhanced clarity an exploded view of the three dimensional elevation view disclosed in FIG. 5. Additionally, FIG. 7b exhibits how high-lift airfoil blade 35a of FIG. 7a would appear being designed with the discretionary variform aerodynamic slots 70 engineered into its convex pressure surface to enhance the aerodynamic lift properties of the airfoil blades of the present invention. From FIG. 7b, those skilled in the art would readily understand how said discretionary variform aerodynamic slots could also be engineered into its concave suction surface to enhance the aerodynamic lift properties of the airfoil blades of the present invention. Such slots can also be formed in the outer surface.

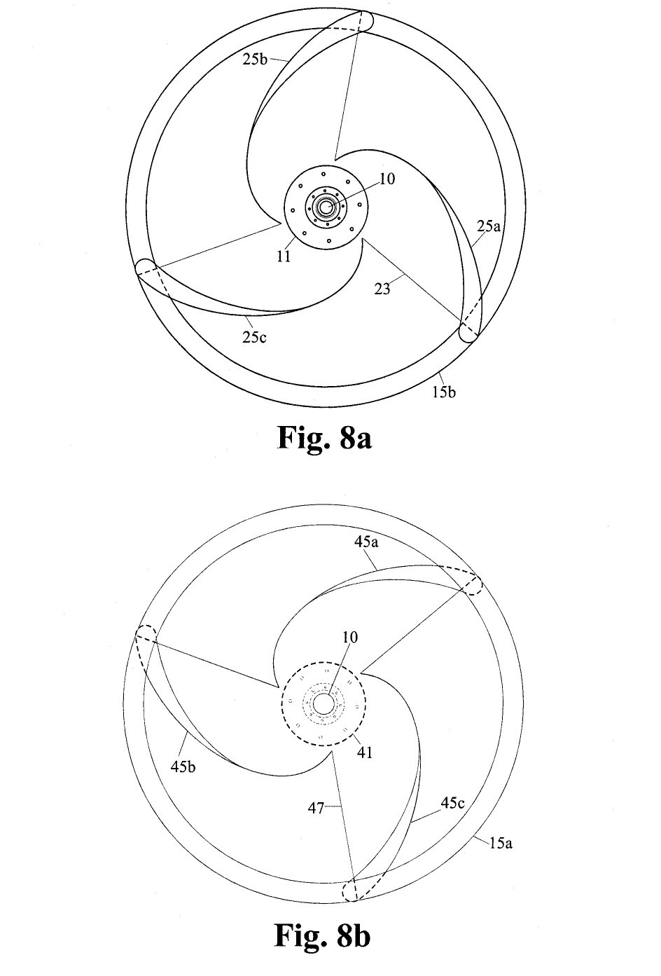

For continued illustration regarding the disclosure of the top or bottom turbine assemblage or construct of the present invention, FIG. 8a shows a sectional view of the three-stage vertical-axis wind turbine of FIG. 1 taken along line 1-1, showing the layout and arrangement of the lower rotor terminus, its reinforcement annulus 15b, its involute airfoil attachment plate 23, its torque transfer plate and tapered expansion hub 11, its axial shaft 10, and its high-lift airfoils blades 25a, 25b, and 25c, showing their helical construction. FIG. 8b is a sectional view of the three-stage vertical-axis wind turbine of FIG. 1 taken along line 3-3, showing the layout and arrangement of the upper rotor terminus, its reinforcement annulus 15a, its involute airfoil attachment plate 47, its torque transfer plate and tapered expansion hub 41, its axial shaft 10, and its high-lift airfoils blades 45a, 45b, and 45c, showing their helical construction. Said annuluses providing stabilization, support, and reinforcement and as disclosed earlier above also provides a rolling, supportive, and protective means for the rotor airfoil blades when the turbine is laid horizontally on the ground or other horizontal surface. Each annulus can be a ring coupled to the distal ends of the petals of the attachment plates 23 and 47.

As described above, the airfoils can generally or substantially have a logarithmic curvature or logarithmically shaped curvature.

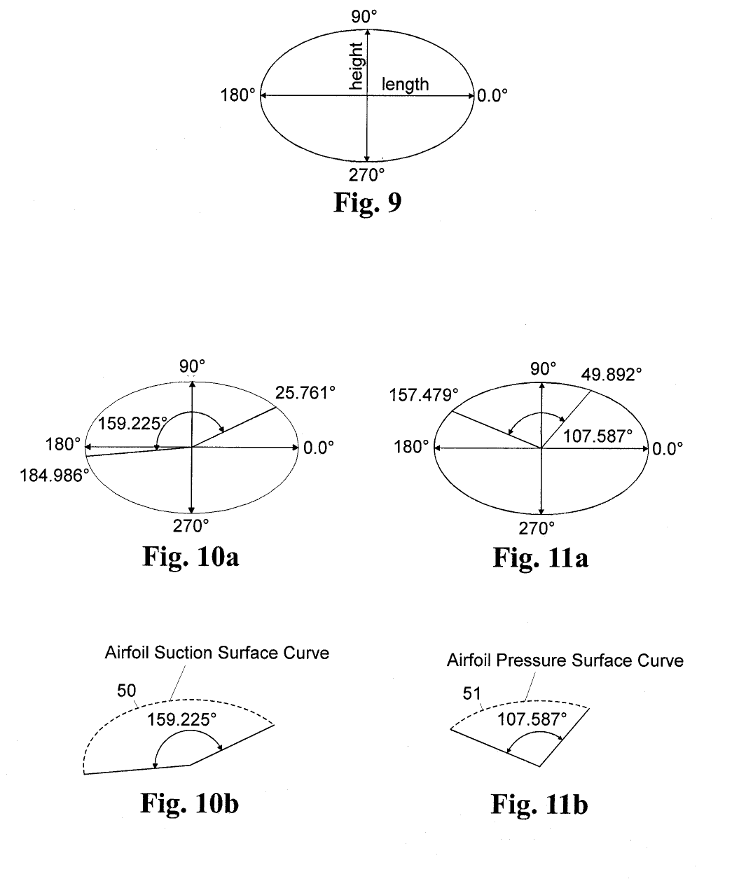

Furthermore, regarding the construct parameters of the airfoil blades of the present invention, FIG. 9 discloses the physical parameters of an ellipse used in the design and construction of the logarithmically curved high-lift airfoils blades for the several rotor stages of FIG. 1, wherein the length of said ellipse is equal to the desired rotor diameter divided by phi or 1.618 and the height of said ellipse is equal to said rotor diameter minus the length of said ellipse. Whereas, FIG. 10a shows an arc segment of the ellipse of FIG. 9, wherein said arc segment represents the logarithmic curve used to construct the outer airfoil suction surface 86 (FIG. 2) of the logarithmically curved high-lift airfoils blades utilized in the several rotor stages of the present invention and wherein the leading edge of said arc segment substantially begins at 25.761 degrees (or approximately 26 degrees) from the zero (0) degree point on said ellipse and rotates in the counter-clockwise direction for a total of 159.225 degrees (or approximately 160 degrees) to form the trailing edge of said arc segment, ending at substantially 184.986 degrees (or approximately 185) of said ellipse. FIG. 10b shows the arc segment 50 generated thereby in FIG. 10a, wherein said arc segment represents the logarithmic curve used to construct the outer airfoil suction surface of the logarithmically curved high-lift airfoils blades utilized in the several rotor stages of the present invention.

FIG. 11a shows an arc segment 51 of the ellipse of FIG. 9, wherein said arc segment represents the logarithmic curve used to construct the inner airfoil pressure surface 84 (FIG. 2) of the logarithmically curved high-lift airfoils blades utilized in the several rotor stages of present invention and wherein the leading edge of said arc segment substantially begins at 49.892 degrees (or approximately 50 degrees) from the zero (0) degree point on said ellipse and rotates in the counter-clockwise direction for a total of 107.587 degrees (or approximately 108 degrees) to form the trailing edge of said arc segment, ending at substantially 157.479 degrees (or approximately 158 degrees) said ellipse.

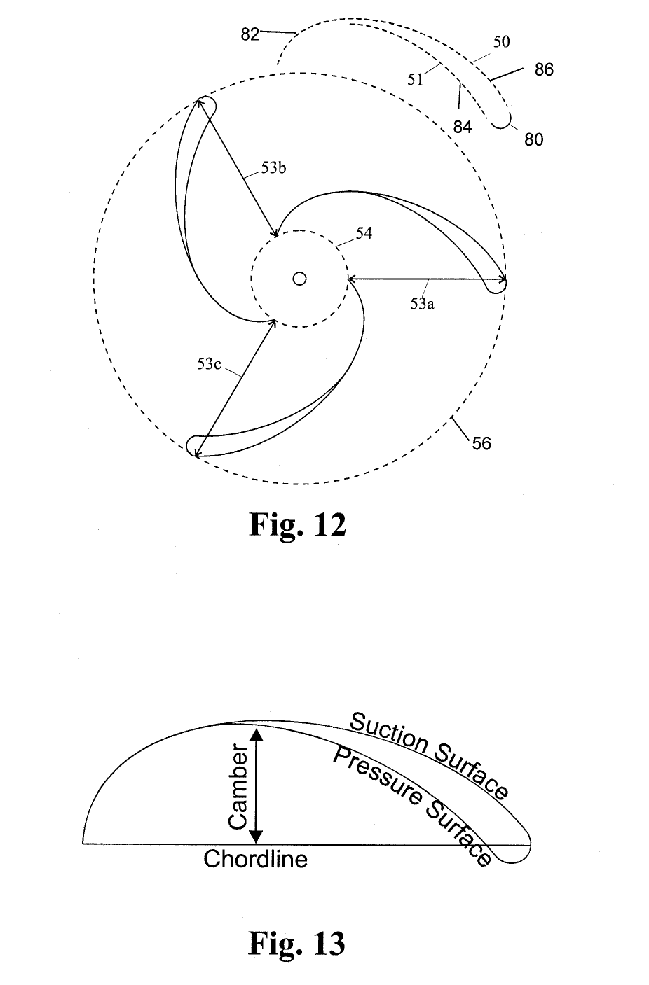

FIG. 12 exhibits how the outer airfoil suction surface arc 50 of FIG. 10b and the inner airfoil pressure surface arc 51 of FIG. 11b are laid out to construct one of the high-lift airfoils blades utilized in the several rotor stages of FIG. 1 of the present invention, said arc segments 50 and 51 having a semicircle spheroidal nose or leading edge 80 attached thereto; said spheroidal nose 80 having a diameter substantially equal to 5.21% that of the desired rotor diameter and radials 53a, 53b, and 53c are equal in length to the height of the ellipse of FIG. 9. The diameter of the central open section of the rotor of the present invention, represented by the dashed inner circle 54, is substantially equal to the desired diameter of the rotor minus twice the length of radials 53a, 53b, and 53c shown in FIG. 12, said open section providing a compressed but substantive unobstructed air flow through the mid-section of said rotor. Said air compression providing a protective bow shock wave created on the upstream side of the rotor to self-limit energy production when wind pressure levels approach destructive levels, said bow shock wave constraining excess wind to flow more easily around the turbine rather than through it. As described above, the logarithmic curvature has a varying radius with the trailing edge having a smaller radius of curvature than the leading edge; and the rotor airfoils are oriented with the leading edge positioned further from the vertical axis than the trailing edge.

For appurtenant illustrative purpose in disclosing the workings of the high-lift airfoil blades of the present invention, FIG. 13 depicts the appreciable camber of the airfoil blades utilized in the several rotor stages of FIG. 1. Such camber or concavity in the construct of said airfoil blades provides appreciable lift and thus torque to the rotor construct of the present invention. Said lift occurring as a result of how the air flows over the outer convex suction surface and the inner concaved pressure surface of said airfoils blades. To illustrate further, the fluid air mass tends to follow the outer curved surface of the airfoil blade rather than flow in a straight line, due to the viscosity of the air “boundary layer” encapsulating its surfaces. This tendency for a fluid to follow a curved surface is known as the Coanda Effect. From Newton's first law we know that for a fluid to bend there must be a force acting upon it. From Newton's third law we know that the fluid must apply an equal and opposite force on the airfoil. This force causes the convex or suction surface of the airfoil blade to move directly into the air stream, rather than away from it due to a reduction in air pressure as a result of the increased air velocity over said surface according to the Bernoulli Principle. Furthermore, as the air channels past the concaved pressure surface of said airfoils blades, a high pressure stagnation area is produced near the spheroidal leading edge of said concaved pressure surface due to a reduction in overall air velocity, according the Bernoulli Principle.

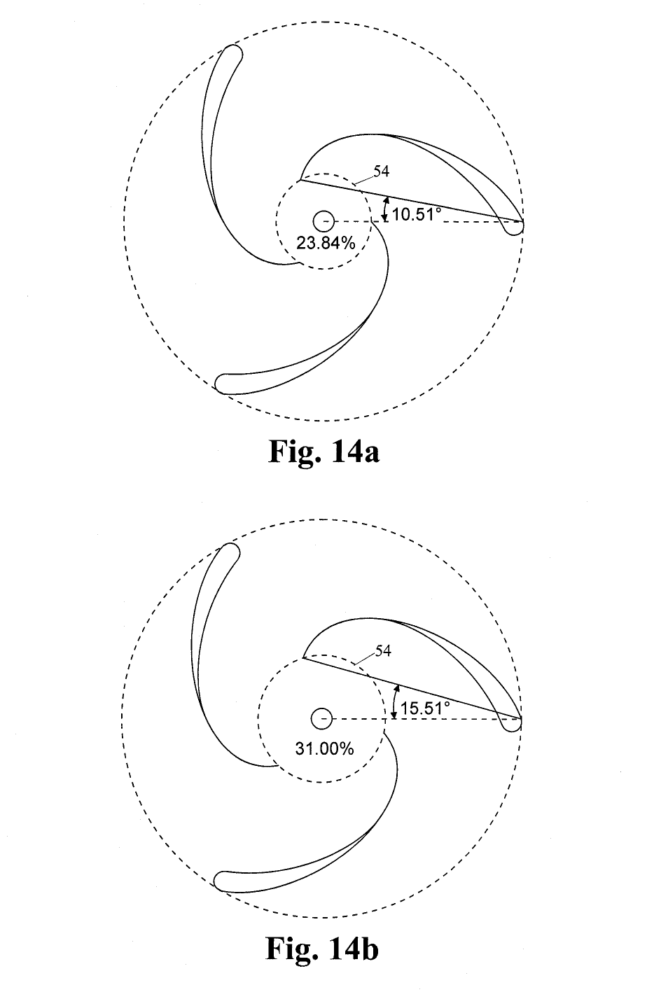

As described above, the diameter of the central open section of the rotor of the present invention, represented by the dashed inner circle 54 of FIG. 12 is shown again in FIG. 14a, wherein, said open section providing a compressed but substantive unobstructed air flow through the mid-section of said rotor. In FIG. 14a, said central open section 54 is being shown in relation to the angular skew of the chord line of the airfoil blades compared to the radius of the rotor of the present invention. FIG. 14a shows the angular skew of the airfoils being set at 10.51 degrees (or approximately 11 degrees) that of the rotor radius, wherein open section 54 is represented by the dashed line formed between the aft section or trailing edge tips of the airfoil blades. Such a skew can provide a protective bow show wave on the upstream side of the rotor. Said open section can have a diameter equal to 23.84% (or approximately 24%) the diameter 56 of the rotor of the present invention defined by the leading edges of the rotor airfoils. Thus, the open section of FIG. 12 is equal to that of FIG. 14a. The trailing edges of the rotor airfoils define a constricted vertical flow configured to increase air velocity through the central portion of the rotor.

However, referring to FIG. 14b, open section 54 has been increased to a diameter of 31.00% the diameter of the rotor by skewing the chord line or angle of attack of the airfoil blades by an angle of 15.51 degrees (or approximately 16 degrees) to that of the rotor radius. Doing so decreases the compression and thus velocity of the air moving through the central portion of the rotor. This alteration also modifies the lift component of the rotor airfoil blades, as well as the stall point of the airfoil blades in relation to velocity of the airstream. Said modification also reduces the protective bow shock wave created on the upstream side of the rotor to self-limit energy production. Thus, those skilled in the art will recognize how these small design changes to the angle of attack and central open section of the rotor provides finesse to the overall design of the rotor of the present invention. For example, the diameter of the center portion of the rotor defined by the trailing edges can be varied between approximately 24-31 degrees. In addition, the chord line of the rotor airfoils can be oriented with an angular skew between approximately 10-16 degrees.

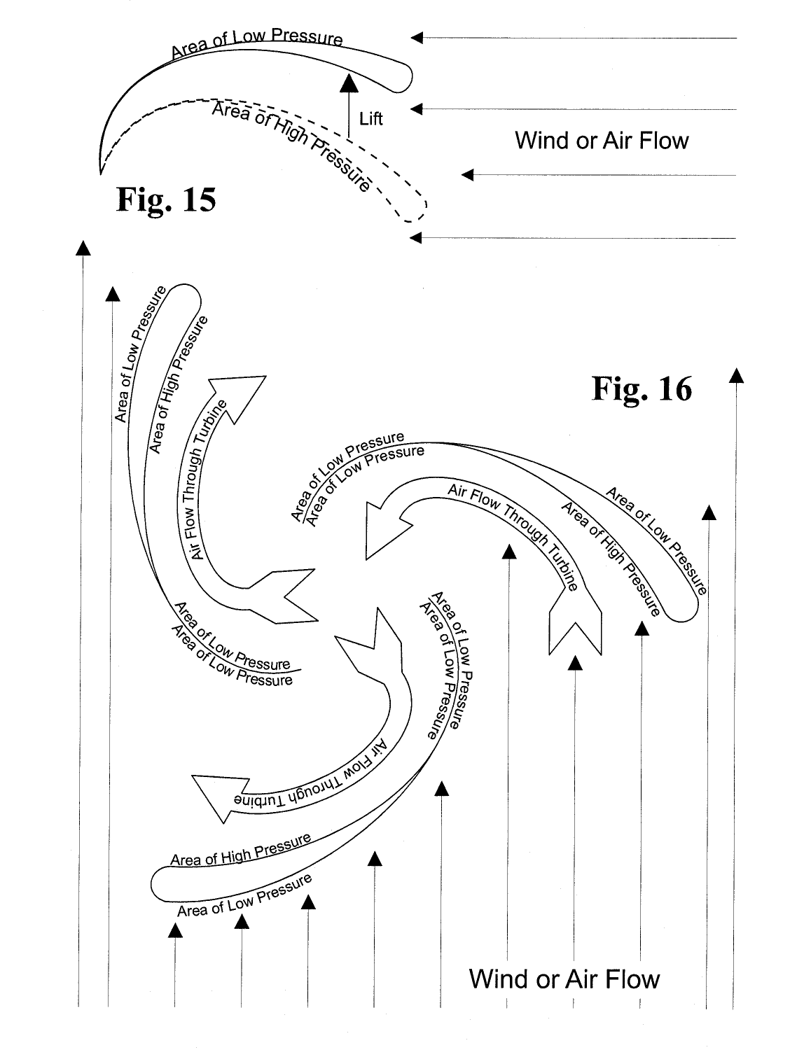

The drawings or illustrations contained in FIG. 15 and FIG. 16 are included for additional clarity as to how lift is generated via the airfoil blades of the present invention by graphically representing, more clearly, how said lift is generated via the curved airfoils blades utilized in the several tiered rotor stages of turbine 5 disclosed in FIG. 1. Accordingly, as shown in FIG. 15, wind or air flowing around said airfoil blades, creates an area of high pressure on the camber or inner side of the blade near the spheroidal leading edge where the air velocity decreases or becomes more stagnant and an area of low pressure is created on the outer or convex side of the blade where the air speed or velocity is increased according to the Bernoulli principle. Continuing, FIG. 16 further illustrates how the wind or air flowing around each rotor airfoil blade of turbine 5 in FIG. 1 forms areas of high and low pressure which results in substantial lift and appreciable rotating torque. Additionally, since all airflow passing through the inner construct of the rotor is substantially compressed by the curvature of the airfoil blades as it passes through the open mid section or vortices of the rotor, the fluid air pressure in said vortices is further reduced due to an increase in the central fluid air velocity, rising once again progressively with distance from rotor center as it exits the turbine through the antipodal airfoil blades in accordance with Bernoulli's Principle. Additionally, FIG. 16 illustrates how at the rotor's central axis, the vorticity or rotary flow of the incoming air flow flip-flops or changes direction as it exits through the remaining antipodal airfoils, producing positive lift and effective torque for a full 360 degrees of rotation, virtually eliminating static back pressure. This flip-flop action of the rotor airflow eventuates three times per revolution or for every 120 degrees of rotation throughout each of the rotor stages. As can also be recognized in the illustrative drawing of FIG. 16 by those skilled in the art, as air flows around the outer boundary of the rotor of the present invention, its velocity accelerates, inducing an area of significant low pressure on the wind shade side or the rotor airfoil blades creating a vacuum due to the Venturi Effect, said vacuum, not only eliminating back pressure, but aiding considerably to the overall torque potential of turbine 5. Consequently according to the Coanda Effect, the Venturi Effect, and the Bernoulli Principle, significant aerodynamic lift is induced upon all the rotor airfoils of the present invention for a full 360 degrees of rotation, said total torque and resulting output power of turbine 5 being based upon the well recognized aerodynamic lift principles disclosed above.

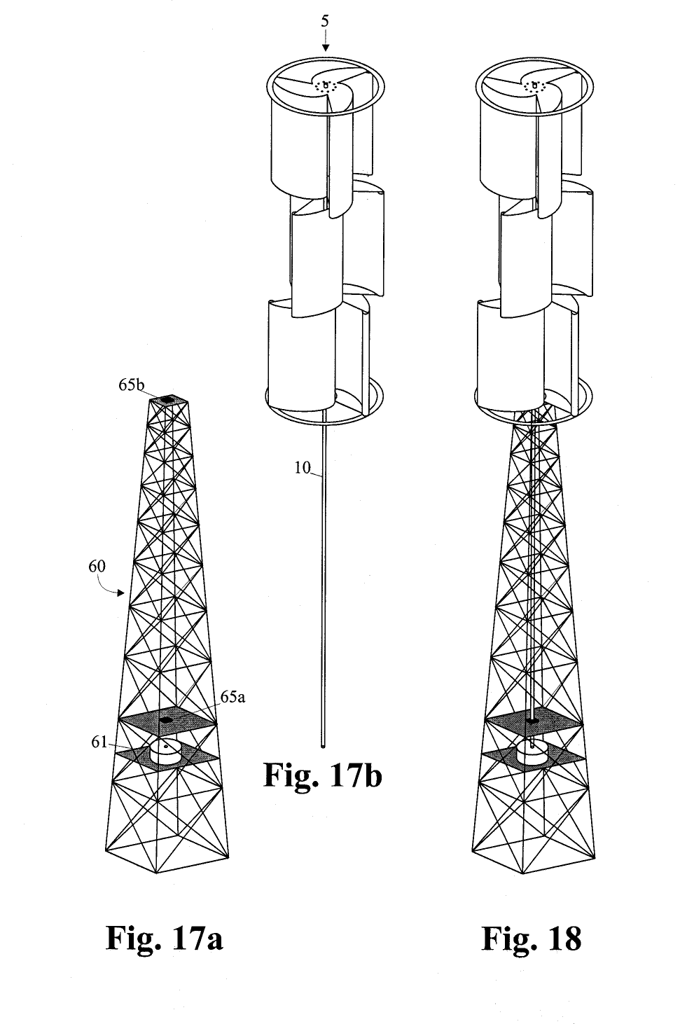

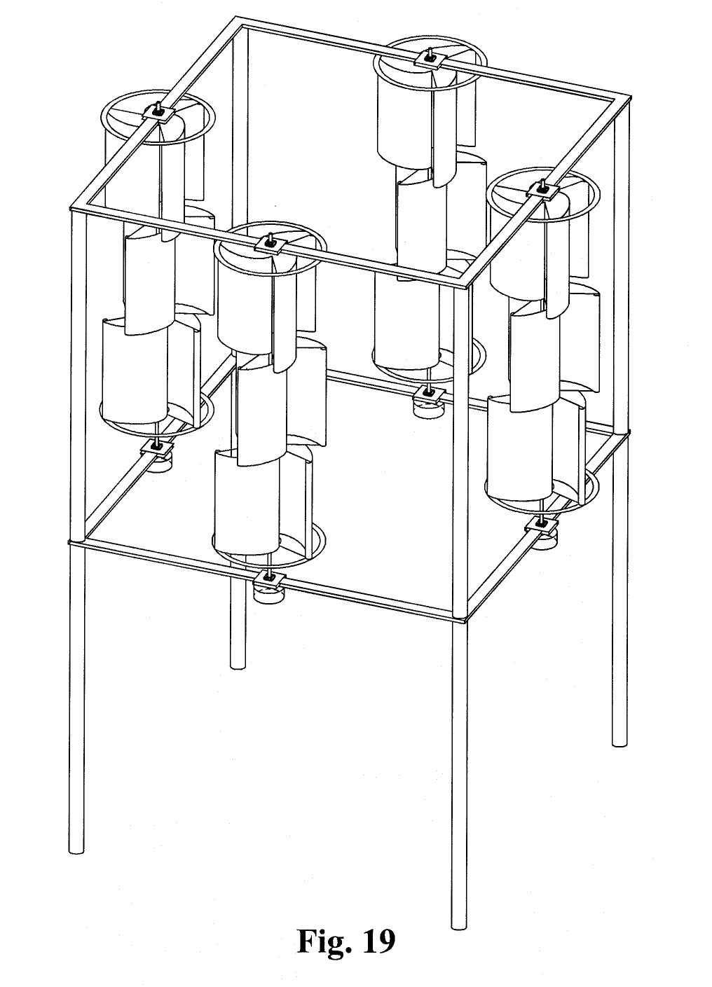

As was stated earlier at the beginning of the disclosure of the present invention, the mounting strategy for rotation and operation was intentionally left open-ended. Accordingly, the drawings contained in FIG. 17a, FIG. 17b, FIG. 18, and FIG. 19 are included as an effective means of representing, more clearly, just a couple of the several mounting strategies that could be utilized for rotation and operation of turbine 5 of FIG. 1 of the present invention. Directing attention to FIG. 17a illustrates a latticework tower arrangement 60 that could be utilized as a supporting means for the operation of turbine 5 of FIG. 1, shown again for convenience in FIG. 17b wherein bearings 65a and 65b would accommodate rotor shaft 10 of turbine 5 and generator 61 would be directly coupled to the lower end of shaft 10 of FIG. 17b. The combining of tower of FIG. 17a with the turbine of the present invention FIG. 17b is shown in FIG. 18. FIG. 19 delineates or depicts with a second illustration, how several turbines of the present invention could be made operable within a small footprint by utilizing a framework for support and operation of several turbine units of the present invention. Wherefore, those skilled in the art will recognize still further mounting schemes such as high-rise buildings and frameworks designed so as to be stacked for the accommodation still further multiple turbine units of the present invention.

From the above disclosure, those skilled in the art will begin to recognize the comprehensive scope and design flexibility that is possible, with respect to the present invention, which yields numerous efficacious variations as to the number rotor tiers as well as to the particular mounting strategies unitized for its operation. It should also be realized by those skilled in the art that minor modifications or deviations can also be made to the airfoil aspect ratio or to the overall contour or shape of the airfoil blades by adding appropriately engineered discretionary laminar flow control mechanisms, such as aerodynamic slots and/or suction grooves, especially in very large turbine elements, thereby, augmenting the aerodynamic lift potential of the apparatus, while concurrently minimizing any ensuing turbulence. In addition, those skilled in the art will also recognize that slight modification in the angle of attack of the airfoil blades such as changing the diameter of the open center construct for the present invention would provide a still further desirable adjustable feature, such as would produce a protective bow shock wave on its upstream side substantial to self-limit energy production when wind pressure levels approach destructive levels, thus constraining excess wind to flow more easily around the turbine rather than through it.

Due to the variety of applications wherein the present invention may be installed, these morphological alternatives comprise an essential design characteristic that may be employed while engineering various embodiments tailored to produce specific power curves, etc.

These modifications comprise discretionary design criteria that may be exercised, in order to govern specific performance and control parameters of the present invention, for various installation site environments.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A wind turbine device, comprising:
a) a rotor rotatable about a vertical axis;
b) the rotor having a plurality of vertically oriented rotor airfoils disposed circumferentially and with equiangular symmetry about the vertical axis;
c) each rotor airfoil having a substantially logarithmic curvature with a trailing edge having a smaller radius of curvature than a leading edge, and with the leading edge positioned further from the vertical axis than the trailing edge.

2. A device in accordance with claim 1, wherein the rotor is stator-less without stationary stator airfoils or stator vanes disposed outside of the rotor.

3. A device in accordance with claim 1, wherein the plurality of rotor airfoils defines a constricted vortical flow configured to increase air velocity through a central portion of the rotor.

4. A device in accordance with claim 1, wherein each rotor airfoil further comprises:
a continuously concave inner surface; and
a continuously convex outer surface.

5. A device in accordance with claim 1, wherein each rotor airfoil further comprises:
a spheroidal nose at the leading edge;
a tapered trailing edge;
a concave inner surface with a logarithmic curvature; and
a convex outer surface with a different logarithmic curvature than the concave inner surface.

6. A device in accordance with claim 1, wherein the leading edges of the plurality of rotor airfoils define a rotor diameter; and wherein the trailing edges of the plurality of rotor airfoils define a center with a diameter between approximately 24-31% of the rotor diameter.

7. A device in accordance with claim 1, wherein each rotor airfoil has a chord line oriented with an angular skew between approximately 10-16 degrees.

8. A device in accordance with claim 1, wherein each rotor airfoil further comprises:
a convex outer surface having a curvature defined by an angular sweep of approximately 159 degrees between approximately 26-185 degrees of an ellipse with a length substantially equal to a diameter of the rotor divided by phi or 1.6, and a height substantially equal to the diameter of the rotor less the length; and
a concave inner surface having a curvature defined by an angular sweep of approximately 108 degrees between approximately 50-158 degrees of the ellipse.

9. A device in accordance with claim 1, wherein the rotor comprises a plurality of rotor modules stacked together with collinear vertical axes; and wherein the plurality of rotor airfoils have a different angular orientation with respect to an adjacent module.

10. A device in accordance with claim 1, wherein the rotor is coupled to a generator.

11. A device in accordance with claim 1, wherein each rotor airfoil further comprises an array of horizontally oriented grooves or slots formed in an inner convex surface, an outer concave surface, or both.

12. A wind turbine device, comprising:
a) a rotor rotatable about a vertical axis without stationary stator airfoils or stator vanes disposed outside of the rotor;
b) the rotor having a plurality of vertically oriented rotor airfoils disposed circumferentially and with equiangular symmetry about the vertical axis;
c) each rotor airfoil having:
i) a spheroidal nose at the leading edge;
ii) a tapered trailing edge;
iii) a continuously concave inner surface with a logarithmic curvature; and
iv) a continuously convex outer surface with a different logarithmic curvature than the concave inner surface;
d) a generator coupled to the rotor.

13. A device in accordance with claim 12, wherein the plurality of rotor airfoils defines a constricted vortical flow configured to increase air velocity through a central portion of the rotor.

14. A device in accordance with claim 12, wherein the leading edges of the plurality of rotor airfoils define a rotor diameter; and wherein the trailing edges of the plurality of rotor airfoils define a center with a diameter between approximately 24-31% of the rotor diameter.

15. A device in accordance with claim 12, wherein each rotor airfoil has a chord line oriented with an angular skew between approximately 10-16 degrees.

16. A device in accordance with claim 12, wherein each rotor airfoil further comprises:
a convex outer surface having a curvature defined by an angular sweep of approximately 159 degrees between approximately 26-185 degrees of an ellipse with a length substantially equal to a diameter of the rotor divided by phi or 1.6, and a height substantially equal to the diameter of the rotor less the length; and
a concave inner surface having a curvature defined by an angular sweep of approximately 108 degrees between approximately 50-158 degrees of the ellipse.

17. A device in accordance with claim 12, wherein the rotor comprises a plurality of rotor modules stacked together with collinear vertical axes; and wherein the plurality of rotor airfoils have a different angular orientation with respect to an adjacent module.

18. A device in accordance with claim 12, wherein each rotor airfoil further comprises an array of horizontally oriented grooves or slots formed in an inner convex surface, an outer concave surface, or both.

19. A wind turbine device, comprising:
a) a rotor rotatable about a vertical axis without stationary stator airfoils or stator vanes disposed outside of the rotor;
b) the rotor having a plurality of vertically oriented rotor airfoils disposed circumferentially and with equiangular symmetry about the vertical axis;
c) each rotor airfoil having:
i) a spheroidal nose at the leading edge;
ii) a tapered trailing edge;
iii) a continuously convex outer surface with a logarithmic curvature defined by an angular sweep of approximately 159 degrees between approximately 26-185 degrees of an ellipse with a length substantially equal to a diameter of the rotor divided by phi or 1.6, and a height substantially equal to the diameter of the rotor less the length; and
iv) a continuously concave inner surface with a different logarithmic curvature than the concave inner surface and defined by an angular sweep of approximately 108 degrees between approximately 50-158 degrees of the ellipse;
d) the plurality of rotor airfoils defines a constricted vortical flow configured to increase air velocity through a central portion of the rotor;
e) the leading edges of the plurality of rotor airfoils define a rotor diameter;
f) the trailing edges of the plurality of rotor airfoils define a center with a diameter between approximately 24-31% of the rotor diameter;
g) each rotor airfoil has a chord line oriented with an angular skew between approximately 10-16 degrees; and
h) a generator coupled to the rotor.

20. A device in accordance with claim 19, wherein each rotor airfoil has a smaller radius of curvature at the trailing edge than at the leading edge, and with the leading edge positioned further from the vertical axis than the trailing edge.

21. A device in accordance with claim 19, wherein the rotor comprises a plurality of rotor modules stacked together with collinear vertical axes; and wherein the plurality of rotor airfoils have a different angular orientation with respect to an adjacent module.

22. A device in accordance with claim 19, wherein each rotor airfoil further comprises an array of horizontally oriented grooves or slots formed in an inner convex surface, an outer concave surface, or both.
